(19) United States
(12) Patent Application Publication
(10) Pub. No.: US 2013/0048425 A1
(43) Pub. Date: Feb. 28, 2013

(54) DIELECTRIC COATING AND APPLICATION PROCESS

(71) Applicant: Jesse L. Thompson, Shepherdsville, KY (US)

(72) Inventor: Jesse L. Thompson, Shepherdsville, KY (US)

(73) Assignee: ALTEC INDUSTRIES, INC., Birmingham, AL (US)

(21) Appl. No.: 13/599,468

(22) Filed: Aug. 30, 2012

Related U.S. Application Data
(60) Provisional application No. 61/528,982, filed on Aug. 30, 2011.

(51) Int. Cl. B05D 7/00; B66C 23/687; B66F 13/00

(52) U.S. Cl. 182/46; 427/160

(57) ABSTRACT

A method of electrically insulating one or more components of a boom assembly involves applying a seamless coating of dielectric material to an outer surface of each of one or more boom assembly components, the boom assembly components being constructed of metal or other electrically conductive material. The dielectric material is applied as a liquid and, when hardened, creates a seamless, electrically insulating barrier on the boom assembly components to which it is applied. A layer of ultraviolet radiation protective material may be applied on top of the layer of dielectric material to protect the dielectric material from ultraviolet degradation. The boom assembly components may be painted or otherwise treated prior to the application of the dielectric material.

### RELATED APPLICATIONS

This non-provisional patent application claims priority benefit with regard to all common subject matter of earlier-filed U.S. Provisional Patent Application No. 61/528,982, filed Aug. 30, 2011 and entitled DIELECTRIC COATING AND APPLICATION PROCESS. The earlier-filed provisional application is hereby incorporated by reference in its entirety into the present application.

### BACKGROUND

1. Field

Embodiments of the present invention relate to a dielectric coating and application process to provide an electrically insulating coating, thus heightening safety in applications involving electric circuits. More particularly, the present invention provides an elastomeric coating and application process to provide an insulating barrier to electrically conductive components of an aerial device being utilized by an operator during a construction or maintenance operation in or around an electrical environment.

2. Related Art

In the electrical and telecommunications industries, aerial devices are commonly used to hoist personnel and equipment and to install and/or perform maintenance operations on utility lines, utility poles, transformers, and other elevated equipment. The aerial devices generally include a telescoping and/or articulating boom mounted to a vehicle. Attached to the boom tip, typically at the most distal portion of the boom, is a platform often referred to as a bucket or basket. The platform is capable of transporting personnel and equipment from the ground to an elevated position and may include one or more supplemental load lifting devices capable of hoisting additional tools and equipment. The platform is controlled through use of a hydraulic or electric control assembly to permit articulation of the boom, e.g., rotation and extension, to best position the platform for access to the work zone. Control stations for the hydraulic or electric control assembly are located on the vehicle and the platform to permit control of the platform by personnel on the ground or on the platform, respectively.

In manufacturing the platform and boom, it is desirable to electrically isolate the platform from the ground through use of platform liners, fiberglass booms and other construction or material-based methods. For instance, the platform is often constructed of fiberglass, although other materials may be used such as wood or metal. To the extent any electrically-conductive materials are utilized such as metal, it is common to cover such via an electrically non-conductive material such as plastic. For instance, installing plastic covers over brackets and metal sections of the boom and the platform has become a standard practice within the industry to provide additional protection to the operator. As an additional measure, personnel can also wear non-conducting protective equipment to provide additional protection against electrocution while operating aerial devices.

The plastic covers used to protect exposed electrically-conductive material are bulky, of poor aesthetic value, easily damaged, and expensive to replace. If a plastic cover becomes damaged, for instance, due to regular wear and tear, a period of time may pass before such is noticed and replaced. American National Standards Institute (ANSI) standard A92.2 requires that all covers provided with the aerial device to be replace should they become damaged. Sometimes, it may be difficult to observe small cracks in plastic covers. If the damaged plastic cover results in exposure of an electrically-conductive part, personnel utilizing the aerial device are at an increased risk of electrocution until the damaged plastic cover is replaced. Thus, it is critical to regularly inspect and replace any damaged plastic covers immediately to avoid electrocution while operating aerial devices. Such inspection and replacement tasks are time consuming and result in considerable downtime of the aerial device, which decreases efficiency and is costly.

### SUMMARY

A method in accordance with an embodiment of the invention comprises applying a seamless coating of dielectric material to a boom assembly component. The dielectric material is applied to the component in liquid form and creates an electrically insulating barrier on the boom assembly component to which it is applied. The method further comprises applying a layer of ultraviolet radiation protective material on top of at least a portion of the dielectric material.

A boom assembly in accordance with another embodiment of the invention comprises a lower boom section constructed of metal and an upper boom section constructed of a non-conductive material. An outer surface of at least a portion of the lower section of the boom is coated with a seamless layer of dielectric material creating an electrically insulating barrier around the portion of the boom to which the dielectric material is applied.

A utility vehicle in accordance with yet another embodiment of the invention comprises a vehicle chassis, a boom turret rotatable relative to the chassis, and a telescoping boom assembly mounted on the boom turret. The boom assembly includes a lower boom section constructed of metal, an upper boom section slidably disposed within the lower section and constructed of fiberglass, and a bucket supported by the upper section and configured to support a person.

An outer surface of the lower boom section is coated with a layer of paint, a layer of polyurethane on top of the layer of paint, and a layer of ultraviolet radiation protective material on top of the layer of polyurethane. The layer of polyurethane creates a dielectric barrier around the portion of the lower section of the boom to which it is applied. The portion of the lower section of the boom coated with polyurethane is distal the boom turret and includes the end of the boom distal the turret and can consist of only part of the total length or include the total length of the lower section of the boom. The ultraviolet radiation protective material is a different color than the polyurethane.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the present invention will be apparent from the following detailed description of the preferred embodiments and the accompanying drawing figures.

### BRIEF DESCRIPTION OF THE DRAWINGS

FIG. 1 is a first utility vehicle including a boom assembly with a bucket configured to hold a worker, the boom assembly including a plurality of components coated with a dielectric material in accordance with embodiments of the invention;

FIG. 2 is a second utility vehicle including a boom assembly with a winch and load line, the boom assembly including at least one component coated with a dielectric material in accordance with embodiments of the invention;

FIG. 3 is an enlarged fragmentary view of the telescoping boom of the first utility vehicle illustrated in FIG. 1;

FIG. 4 is a cross-sectional view of the boom of FIG. 3 illustrating layers of paint, dielectric material and UV protective material applied to the boom;

FIG. 4a is an enlarged fragmentary view of the cross section of FIG. 4, illustrating the layers of paint, dielectric material and UV protective material applied to the boom; AND

FIG. 5 is an enlarged, fragmentary, partially exploded view of the boom of FIG. 4 illustrating first and second protective covers removed from the boom.

The drawing figures do not limit the present invention to the specific embodiments disclosed and described herein. The drawings are not necessarily to scale, emphasis instead being placed upon clearly illustrating the principles of the invention.

### DETAILED DESCRIPTION

The following detailed description references the accompanying drawings that illustrate specific embodiments in which the invention may be practiced. The embodiments are intended to describe aspects of the invention in sufficient detail to enable those skilled in the art to practice the invention. Other embodiments can be utilized and changes can be made without departing from the scope of the present invention. The following detailed description is, therefore, not to be taken in a limiting sense. The scope of the present invention is defined only by the appended claims, along with the full scope of equivalents to which such claims are entitled.

In this description, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, step, etcetera described in one embodiment may also be included in other embodiments, but is not necessarily included. Thus, the present technology can include a variety of combinations and/or integrations of the embodiments described herein.

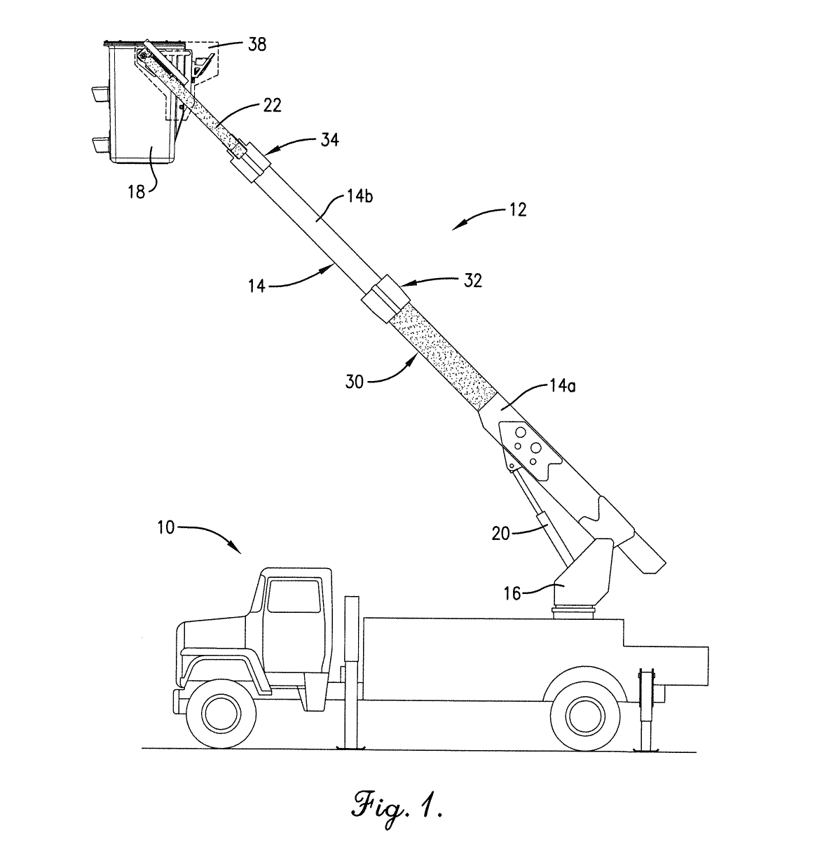

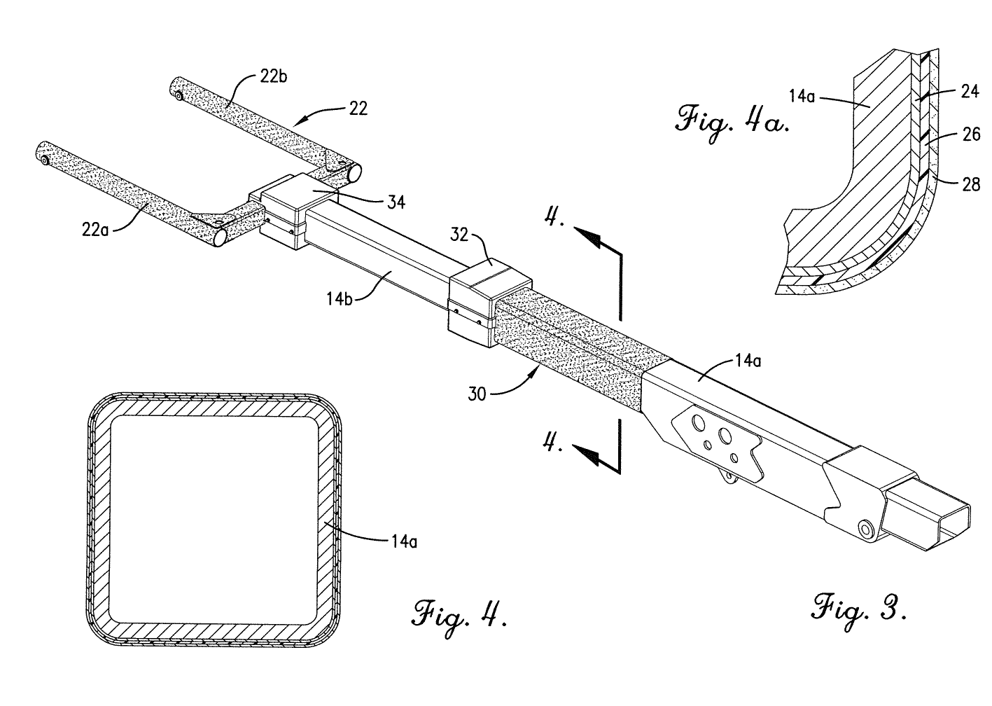

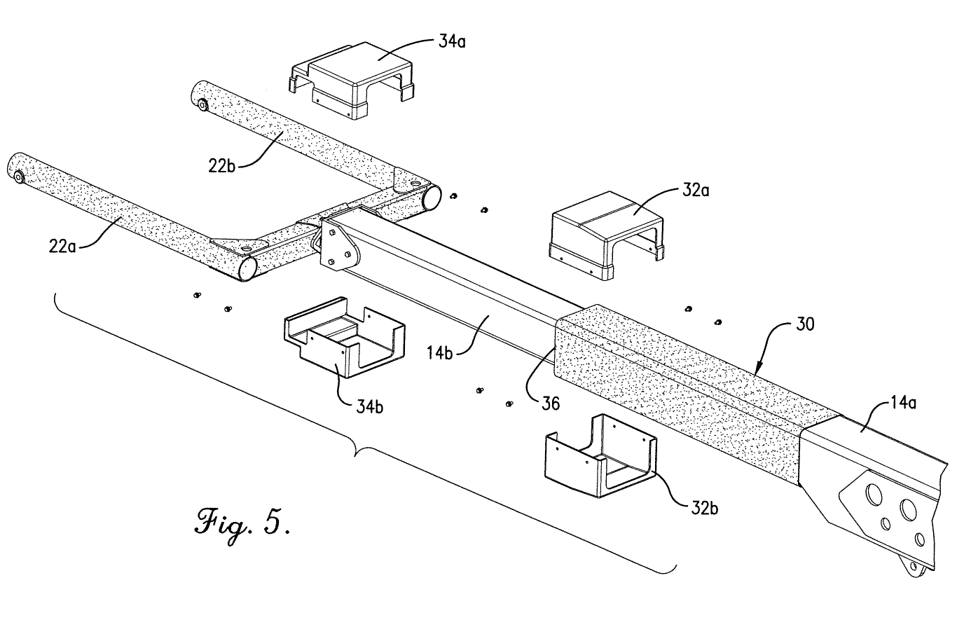

Turning now to the drawings, and in particular FIGS. 1 and 3-5, an exemplary utility vehicle 10 with a boom assembly 12 including a boom 14 and boom turret 16 constructed according to an exemplary embodiment of the present invention is illustrated. The boom assembly 12 is mounted on the vehicle 10 to enable rotational and/or pivotal movement of the boom 14 relative to a chassis of the vehicle 10 and includes a bucket 18 for supporting a technician or other person in a conventional manner. The illustrated boom 14 comprises a plurality of nested boom sections 14a, 14b that may be telescopically extended and retracted and a piston and cylinder assembly 20 for pivoting the boom 14 up and down relative to the vehicle 10.

A pulling arm assembly 22 is mounted on an outer end of the upper boom section 14b. The pulling arm assembly 22 includes left 22a and right 22b pulling arms rotatably attached to opposing sides of the bucket 18. The arms 22a and 22b are attached to the bucket 18 proximate a top thereof, allowing the bucket 18 to remain in an upright position regardless of the angle of the boom 14.

Because the vehicle 10 may be used in environments with power transmission/distribution lines, transformers or other electrically energized elements, the boom assembly 12 is configured to protect a person in the bucket 18 from inadvertent electric discharge, such as may occur if a portion of the bucket 18 or boom 14 contacts a power transmission/distribution line. In particular, various components of boom assembly 12 are constructed of electrically non-conductive material to prevent an electric current from flowing through the bucket 18 or the boom 14. The bucket 18 and the upper section 14b of the boom 14, for example, are constructed of fiberglass or other non-conductive material. Eliminating conductive paths through the bucket 18 and the boom 14 reduces the risk of operators in the bucket 18 or in or near the vehicle 10 suffering electric shock. Some components of the boom assembly 12 may be constructed of metal or other conductive material, however, to maximize structural strength, to minimize cost, or for other reasons. Such conductive components create a potential path for electric current thus pose a risk of inadvertent and undesirable electric discharge.

Embodiments of the present invention provide a method of protecting conductive components of the boom assembly 12 from electrical discharge in a manner that minimizes interference with operation of the boom assembly 12. Generally, the method includes applying a coating of dielectric material to conductive components of the boom assembly 12. In the embodiment illustrated and described herein, the dielectric material is applied to the boom assembly components as a liquid and hardens such that it bonds to the components and forms a continuous and seamless electrically insulating barrier on the surface of the components.

Applying the dielectric coating in a liquid form has various advantages. The resulting layer of dielectric material is relatively thin and has a low profile, thus minimizing interference with operation of the vehicle 10 and boom assembly 12. The dielectric material is also durable and resilient, physically protecting the underlying components and reducing the risk that the dielectric material itself will become damaged. Additionally, when applied in liquid form, the dielectric material may be applied such that the resulting layer of dielectric material is seamless. It will be appreciated that a seamless insulating barrier around each of the boom assembly components is important when the components are exposed to electric power sufficient strong to generate an electric current through relatively small seams in electrically insulating material.

The dielectric coating may be applied to virtually any components of the boom assembly 12. The particular embodiment of the invention illustrated in the figures and described herein includes a dielectric coating applied to one of the boom sections 14a, 14b and to the pulling arm assembly 22, as explained below in greater detail. It will be understood, however, that the invention is not limited to these or any other boom assembly components. Furthermore, one or more other materials or chemicals may be applied to the boom assembly components in addition to the dielectric material to further protect the components, the dielectric material, or both. In particular, it may be desirable to apply a layer of paint to the boom assembly components prior to applying the dielectric material, and it may be desirable to apply a UV protective material on top of the dielectric material to prevent UV degradation of the dielectric material. Each of these components is described in greater detail below.

A layer of paint 24 may be applied to an outer surface of the components to be protected. The paint 24 may be applied directly to the outer surface of the components before the dielectric material 26 and the UV protective coating 28, thus comprising the first of two or more protective layers applied to the boom assembly components. The paint 24 may be a conventional paint configured to protect the components against corrosion and other effects of a construction and maintenance environment, such as exposure to the natural elements and to chemicals and substances such as oil, grease, diesel fuel, gasoline, mud and de-icing chemicals. Where a layer of dielectric material 26 is applied over the layer of paint 24, properties of the paint 24 and the dielectric material 26 should permit the dielectric material 26 to bond with or adhere to the paint 24.

The paint 24 may be applied in a conventional manner by, for example, spraying, rolling or brushing it onto the components in liquid form. Alternatively, the paint 24 may be applied as a powder, wherein electric charges are used to adhere the paint 24 to the components in powder form and the components are heated and cooled to cause the paint 24 form as a solid layer. In some cases it may not be practical or desirable to apply a layer of paint to one or more of the components, such as where the size or shape of a component is incompatible with the user's painting equipment. In such instances, the surface of the components may be prepared according to another method. The surface may be cleaned to remove any impurity in preparation for applying the dielectric material 26 directly to the surface.

The thickness of the layer of paint 24 may vary substantially from one implementation of the invention to another without departing from the spirit or scope of the invention. By way of example, in one embodiment of the invention the paint 24 is applied at a thickness preferably within the range of from about 0.001 inches to about 0.010 inches, more preferably within the range of from about 0.002 inches to about 0.008 inches, and may particularly be about 0.003, 0.004, 0.005, or 0.006 inches thick.

The layer of dielectric material 26 is applied on top of the layer of paint 24 or, if no paint is applied, directly to an outer surface of the boom assembly components. The dielectric material 26 provides an electrically insulating protective barrier around the boom assembly components, thus protecting the equipment and users from inadvertent and undesirable electric discharge, as explained above.

The dielectric material 26 is preferably applied to the boom assembly components in liquid form and allowed to reform into a solid coating that bonds to the layer of paint 24, or to the surface of the components if no paint is applied. In this manner, the dielectric material 26 forms a seamless electrically insulating coating on the components that closely adheres to the components and presents a relatively low profile. Depending on the type of dielectric material used, it may also provide a durable, waterproof, impact and chemical resistant protective barrier around the components. As used herein, a material forms a “coating” on a surface when it covers the surface and bonds to the surface or a layer of material on the surface. As used herein, a layer or coating is “seamless” if it is integrally formed as a single piece and presents no apertures or holes through which an electric current may pass.

The dielectric material 26 may be a polymer, such as an elastomeric polymer including polyurethane or polyurea. In one exemplary embodiment, the dielectric material is polyurethane. The polyurethane may be stored and/or applied as two components, a hardener and a resin. The components may be heated and combined immediately prior to application, such as just before entering a spray gun, inside the spray gun, or immediately after leaving the spray gun nozzle. As used herein, “immediately prior to application” means within a few seconds prior to application, such as within five seconds. Various polyurethane application processes may be used without departing from the scope of the invention, including conventional methods.

The dielectric material 26 may be applied at any of various thicknesses determined, at least in part, by the dielectric strength of the material 26, requirements imposed by laws and regulations, and the desired dielectric capacity of the dielectric layer 26. If the target dielectric capacity of the dielectric layer 26 is desired or required to be at least 5,000 volts, for example, and the dielectric strength of the dielectric material is 300 V/mil, the dielectric material may be applied at a thickness of 0.017 inches for a total dielectric capacity of 5,100 volts. If the dielectric strength of the dielectric material is 400 V/mil, the dielectric material may be applied at a thickness of 0.013 inches for a total dielectric capacity of 5,200 volts. It will be appreciated by those skilled in the art that these numbers are exemplary in nature and that the dielectric strength and the thickness of the material 26 may vary from these values without departing from the scope of the invention. The dielectric material 26 may have a dielectric strength, for example, of 200 V/mil or 500 V/mil. Other considerations that may affect the overall thickness of the dielectric material 26 include the desired physical strength of the dielectric layer 26, the space available in the vicinity of the components to which it is applied, the cost of the dielectric material and limitations of the equipment used to apply the dielectric material 26.

For these reasons, the total thickness of the dielectric material 26 may vary from one embodiment of the invention to another without departing from the scope of the invention. In one exemplary embodiment of the invention, the total thickness of the dielectric material is preferably within the range of from about 0.001 inches to about 0.5 inches and more preferably within the range of from about 0.005 inches to about 0.250 inches. The total thickness of the dielectric material may particularly be about 0.013 inches, 0.017 inches, 0.050 inches, 0.100 inches or 0.125 inches.

As explained above, the dielectric material 26 is preferably sufficiently durable to withstand the rigors of a construction or maintenance environment. In one embodiment of the invention, the hardened dielectric material 26 preferably has a Shore A hardness of at least 50 (under the ASTM D-2240 test), more preferably at least 60, and most preferably at least 70. In another embodiment of the invention, the dielectric material 26 preferably has a Shore A hardness within the range of from about 50 to about 120, more preferably within the range of from about 60 to 110, and that may particularly be about 80, 85 or 90. In one embodiment of the invention, the dielectric material 26 preferably has a tensile strength of at least 1200 and more preferably at least 1500 psi, and may particularly be about 1700 psi, about 1800 psi, about 1900 psi or about 2000 psi under the ASTM D-412 test. In one embodiment of the invention, the dielectric material 26 preferably has an elongation percentage of at least 200, and more preferably at least 250 under the ASTM D-412 test. In one embodiment of the invention, the dielectric material 26 preferably has a tear resistance of at least 150 pli and more preferably at least 200 pli under the ASTM D-624 test.

Exemplary commercially available polyurethane products meeting these standards include the Rhino TUFF STUFF® spray-on lining sold by RHINO LININGS® and the XS-100 spray-on lining sold by LINE-X PROTECTIVE COATINGS.

Depending on the properties of the dielectric coating 26, the dielectric coating 26 may be subject to ultraviolet degradation. This is a relatively common phenomenon with polymers, particularly if the material is exposed to excessive ultraviolet (UV) radiation, such as sunlight. Ultraviolet degradation causes the material to become discolored or faded and, of greater concern, can compromise the structural integrity of the material resulting in weakening, warping, cracking or breaking. It will be appreciated that such damage to the dielectric material 26 diminishes or completely comprises its function as an electrical insulator. If the dielectric material 26 is susceptible to ultraviolet degradation, steps may be taken to protect the dielectric material from ultraviolet radiation.

In the illustrated embodiment, a layer of non-conductive material 28 configured to protect against ultraviolet degradation is applied over the dielectric material 26. The UV radiation protective material 28 may be in the form of paint and contains elements for absorbing UV radiation or otherwise preventing the UV radiation from reaching the underlying dielectric material 26. By way of example, ingredients that block UV radiation include titanium dioxide, zinc oxide and cerium oxide. An example of a commercially available UV protective material is the COLORCOAT product sold by ARMORTHANE.

The UV protective material shields the underlying layer of dielectric material from UV radiation sufficiently to prevent UV degradation. Thus, the exact level of UV protection provided by the UV protective material may vary from one embodiment of the invention to another. In some embodiments, the UV protective material may need to block or absorb at least 70% of UV radiation to be effective, while in other embodiments the UV protective material may need to block or absorb at least 80% or 90% of UV radiation to be effective.

The UV protective material 28 is preferably a different color than the dielectric coating 26 to facilitate detection of the loss of the UV protective material 28. By way of example, the UV protective coating 28 may be a white or cream color while the dielectric coating may be black. In this scenario, if a portion of the UV protective material 28 is inadvertently removed, the black dielectric material 26 will be visible through the removed portion of the UV protective layer 28, thus alerting users who may then inspect the dielectric material 26 for damage and repair the layer of UV protective material 28 by, for example, applying additional UV protective material 28.

As explained above, the dielectric material 26 (as well as the paint 24 and the UV protective material 28) may be applied to any components of the boom assembly 12. In one embodiment of the invention, the dielectric material 26 is applied to components of the boom 14 that are constructed of a conductive material, such as metal, and that are within a predetermined distance of the bucket 18 or end of the boom 14. By way of example, the distance may be ten feet, eight feet, six feet or four feet and may be related to the anticipated reach of a person positioned in the bucket.

In the illustrated embodiment, the pulling arm assembly 22 is constructed of metal and is substantially entirely covered with a layer of the dielectric material 26. Additionally, a portion 30 of the lower section 14a of the boom 14 is covered with the dielectric material 26. It is desirable to protect the portion 30 with the dielectric material 26 because when the boom 14 is in a retracted position (that is, when the upper section 14b of the boom 14 is retracted within the lower section 14a of the boom 14) the portion 30 of the lower boom section 14a is proximate the bucket 18. In the illustrated embodiment, the upper boom section 14b is constructed of fiberglass or other non-conductive material.

The boom assembly 12 may include one or more protective covers 32, 34 to provide additional electric insulation, particularly at potentially vulnerable points, such as where boom assembly components are adjoining and are not sufficiently electrically insulated. A first protective cover 32 is placed on the boom 14 at the intersection of the lower boom section 14a and the upper boom section 14b. This point on the boom assembly 12 can present an electric shock hazard because the end 36 of the lower boom section 14a may not be completely covered with dielectric material and, if it is, portions of the dielectric material may wear thin or fall off with use as the upper boom section 14b telescopes into and out of the lower boom section 14a.

Furthermore, even if the end 36 of the lower boom section 14a is completely and adequately coated with dielectric material 26, the inside surface of the lower boom section 14a (adjacent the outer surface of the upper boom section 14b) typically lacks electric insulation because it is adjacent, and engages, the outer surface of the upper boom section 14b. Because the inside surface of the lower boom section 14a is not electrically insulated, portions of the inside surface proximate the end 36 of the lower boom section 14a are within range of electrical discharge. For example, an electrical component, or a user who is in contact with an electrical component, that touches or is near the upper end 36 of the lower boom section 14a, may discharge an electric current through an arc that jumps from the electric component to the inside surface of the lower boom section 14a.

The first protective cover 32 addresses this potential hazard by encasing the end 36 of the lower boom section 14a with an insulating shell that is configured to create a protective space around the end 36 of the lower boom section 14a. The shell is constructed of a polymer or other electrically insulating material and may comprise two sections, a top section 32a and a bottom section 32b. Dielectric fasteners secure the two sections 32a, 32b of the shell around the boom 14 such that the protective cover 32 encases the end 36 of the lower boom section 14a. Secured in place, the protective cover 32 creates a protective gap or space around the end 36 that keeps a person or component at a safe distance from the end 36 of the lower boom section 14a. The safe distance is such that the dielectric strength of the air in the space is sufficient to prevent electric arcing through the space.

The size of the space may vary from one implementation to another and may be configured to protect against hazards of the environment in which the utility vehicle will be used. In environments including higher power electrical components a larger space may be necessary, while a smaller space may be necessary for use in environments with lower power electrical components. The size and configuration of the protective cover 32 will also typically be influenced by space considerations. Larger covers will typically provide greater protection against high voltage discharges, but also occupy more space and may thus be more susceptible to damage. By way of example, the space created by the protective cover may be 0.5 inches, 1.0 inches or 1.5 inches.

The second protective cover 34 is similar in form and function to the first cover 32, except that the second cover 34 is configured to encase and protect components at the intersection of the upper boom section 14b and the pulling arm assembly 22. Like the first protective cover 32, the second protective cover 34 comprises a top section 34a and a bottom section 34b secured together with dielectric fasteners. A shroud 38 may be placed on the bucket 18 to encase and protect various components positioned outside the bucket 18 and thus exposed to power transmission/distribution lines and other hazards.

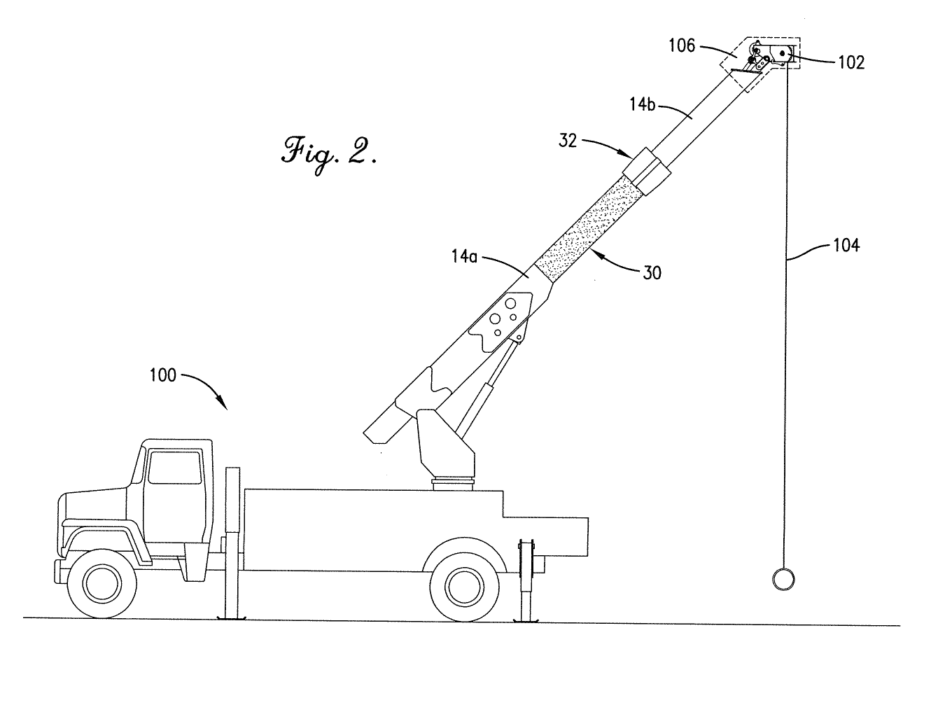

A utility vehicle 100 constructed in accordance with a second embodiment of the invention is illustrated in FIG. 2. The vehicle 100 is substantially similar to the vehicle 10 except that the vehicle 100 has a pulley 102 and load line 104 for hoisting loads instead of a pulling arm assembly and bucket. An optional shroud 106 may protect exposed conductive components at the end of the boom.

Although the invention has been described with reference to the exemplary embodiments illustrated in the attached drawings, it is noted that equivalents may be employed and substitutions made herein without departing from the scope of the invention as recited in the claims. For example, while the dielectric material 26 is described and illustrated for use with the telescoping boom 14, the invention is not so limited but may be used with other aerial devices, digger derricks, cranes, or pressure diggers, such as articulating, stacked, side-by-side or fixed-length booms and jibs.

Having thus described various embodiments of the invention, what is claimed as new and desired to be protected by Letters Patent includes the following:

1. A method comprising:
applying a seamless coating of dielectric material to a boom assembly component, the dielectric material being applied to the component in liquid form and creating an electrically insulating barrier on the boom assembly component to which the dielectric material is applied; and
applying a layer of ultraviolet radiation protective material on top of at least a portion of the dielectric material.

2. The method of claim 1, the boom assembly component being one of a plurality of boom sections.

3. The method of claim 1, the dielectric material being polyurethane.

4. The method of claim 3, further comprising combining a plurality of liquid components to form the polyurethane, the components including a hardener and a resin and being combined immediately prior to being applied to the boom assembly component.

5. The method of claim 1, the dielectric material having a Shore A hardness within the range of 70 to 90 and a tear resistance of at least 200 pli.

6. The method of claim 1, the dielectric material having a dielectric strength of at least 300 V/mil.

7. A boom assembly comprising:
a lower section constructed of metal; and
an upper section constructed of a non-conductive material,
an outer surface of at least a portion of the lower section of the boom being coated with a seamless layer of dielectric material creating an electrically insulating barrier around the portion of the boom to which the dielectric material is applied.

8. The boom of claim 7, the portion of the lower section of the boom coated with the dielectric material being a longitudinal portion proximate the upper section and being less than two-thirds of a total length of the lower section of the boom.

9. The boom of claim 7, the dielectric material being an elastomeric polymer.

10. The boom of claim 9, the dielectric material being polyurethane.

11. The boom of claim 7, the outer surface of the lower section of the boom being coated with a layer of paint beneath the layer of dielectric material.

12. The boom of claim 7, further comprising a layer of ultraviolet radiation protective material on top of at least a portion of the layer of dielectric material.

13. The boom of claim 12, the ultraviolet radiation protective material being a different color than the dielectric material to visibly indicate when the ultraviolet radiation protective material has worn sufficiently to expose the dielectric coating.

14. The boom of claim 7, the upper section of the boom being constructed of fiberglass.

15. The boom of claim 7, the upper section of the boom being slidably disposed within the lower section of the boom.

16. The method of claim 7, further comprising a protective cover around the boom at the intersection of the lower section and the upper section, the protective cover including a dielectric shell configured to create a space of at least one inch between the outer surface of the end of the lower section of the boom and an outer surface of the shell.

17. A utility vehicle comprising:
a vehicle chassis;
a boom turret rotatable relative to the chassis; and
a telescoping boom assembly mounted on the boom turret, the boom assembly including—
a lower boom section constructed of metal,
an upper boom section slidably disposed within the lower section and constructed of fiberglass, and
a bucket supported by the upper section and configured to support a person,
an outer surface of the lower section being coated with a layer of paint, a portion of the lower section being coated with a layer of polyurethane on top of the layer of paint and a layer of ultraviolet radiation protective material on top of the layer of polyurethane, the layer of polyurethane creating a dielectric barrier around the portion of the lower section of the boom to which the dielectric material is applied, the portion of the lower section of the boom coated with polyurethane being distal the boom turret, including the end of the boom distal the turret, and being less than one-half of a total length of the lower section of the boom,
the ultraviolet radiation protective material being a different color than the polyurethane.

18. The utility vehicle of claim 17, further comprising a protective cover surrounding a portion of the boom at the intersection of the lower boom section and the upper boom section, the protective cover including a dielectric shell configured to create a space of at least one inch between the outer surface of the end of the lower boom section and the shell.

19. The utility vehicle of claim 17, the polyurethane presenting a Shore A hardness within the range of 70 to 90.

20. The utility vehicle of claim 17, the boom assembly further including a pair of pulling arms mounted on the upper section of the boom and supporting the bucket, an outer surface of the pulling arms being coated with a layer of paint, at least a portion of the pulling arms being coated with a layer of polyurethane on top of the layer of paint and a layer of ultraviolet radiation protective material on top of the layer of polyurethane, the layer of polyurethane creating a dielectric barrier around the portion of the pulling arms to which the dielectric material is applied.
